(19) United States
(12) Patent Application Publication
(10) Pub. No.: US 2025/0229350 A1
(43) Pub. Date: Jul. 17, 2025

(54) SKIVING TOOL AND METHOD FOR MACHINING TOOTH FLANKS OF TEETH

(71) Applicant: Reishauer AG, Wallisellen (CH)

(72) Inventors: Hartmut Marx, Wallisellen (CH); Christoph Leonhardt, Wallisellen (CH); Maximilian Zimmer, Wallisellen (CH)

(73) Assignee: Reishauer AG, Wallisellen (CH)

(21) Appl. No.: 19/098,870

(22) Filed: Apr. 2, 2025

Related U.S. Application Data
(63) Continuation of application No. PCT/EP2024/057253, filed on Mar. 19, 2024.

(30) Foreign Application Priority Data
Apr. 11, 2023 (EP) 23167415.1

(51) Int. Cl. B23F 5/16; B23F 21/10

(52) U.S. Cl. CPC B23F 5/163; B23F 21/10

(57) ABSTRACT

Disclosed is a skiving tool for machining teeth where machining marks are produced at unequal distances. Some cutting edges of a skiving tool at least partially extend at different heights along a tool axis. During machining, cutting edges arranged at different axial heights relative to the workpiece axis successively engage on a tooth flank. The engagement of the cutting edges occurs at different time intervals and at different distances in the width direction of the tooth flank. The effects of the engagement of the cutting edges on the machining process and the excitation of vibrations when the teeth produced are used therefore have a frequency spectrum of greater width and lower amplitude than if the cutting edges were to engage at equal time intervals and equal distances. The more irregular surface structure of the teeth have a positive effect on noise excitation behavior when teeth are engaging with other teeth.

### CROSS-REFERENCE TO RELATED APPLICATIONS

This continuation application claims priority to PCT/EP2024/057253 filed on Mar. 19, 2024 which has published as WO 2024/213349 A1 and also the European application number 23167415.1 filed on Apr. 11, 2023, the entire contents of which are fully incorporated herein with these references.

### DESCRIPTION

### Field of the Invention

The invention relates to a skiving tool for machining tooth flanks of teeth of a workpiece, in which the skiving tool is rotated about a tool axis and the workpiece is rotated about a workpiece axis running skew to the tool axis, wherein the skiving tool and the workpiece are displaced relative to one another with a feed motion with a component along the workpiece axis, wherein the skiving tool has a plurality of cutting edges which successively remove material from the same tooth flank when machining the workpiece. The invention further relates to a method for machining tooth flanks of teeth of a workpiece by skiving, in which a skiving tool is brought into engagement with the teeth, wherein the skiving tool is rotated about a tool axis and the workpiece is rotated about a workpiece axis running skew to the tool axis, and wherein the skiving tool and the workpiece are displaced relative to one another by a feed motion with a component along the workpiece axis.

### Background of the Invention

Such skiving tools and skiving methods are known in principle, for example from EP 3 528 989 B1 or from EP 2 537 616 A1.

Various methods are known for producing teeth. Examples of machining processes include hobbing, planing, shaping or generative grinding. So-called skiving is a continuous cutting process for machining teeth. Important skiving fundamentals and terms are explained, for example, in EP 3 528 989 B1. Skiving enables external teeth as well as internal teeth to be precisely produced.

In skiving, a skiving tool is rotated about a tool axis and a workpiece is rotated about a workpiece axis that runs skew to the tool axis. At the same time, a feed motion occurs, typically along the workpiece axis. The skiving tool has a plurality of cutting edges. A rake face is typically arranged on one end face of the skiving tool; a tool flank usually extends in the axial direction or at a helix angle to the tool axis.

During skiving, machining tracks, so-called feed marks, are created due to the discrete engagement of the cutting edges. In known methods, each of these feed marks are equally spaced apart. When rolling the teeth with mating teeth, the equidistant feed marks can lead to uniform excitation. This is disadvantageous in terms of noise generation.

It is known from DE 11 2017 000 162 T5 that cutting edges on a skiving tool can be arranged at different axial heights such that they collectively form a cutting edge portion for machining a flank of the teeth of the workpiece. First, a first rough cutting edge, then a second rough cutting edge and finally a fine cutting edge come into contact with the workpiece. In this way, the teeth of the workpiece are subjected to rough and fine machining in immediate succession.

### SUMMARY OF THE INVENTION

### Object of the Invention

An object of the invention is to enable noise-optimized teeth to be skived.

### DESCRIPTION OF THE INVENTION

According to the invention, this object is achieved by a skiving tool having the features specified in claim 1, and by a method according to another claim.

Advantageous embodiments and variants are specified in each of the dependent claims and the description.

Skiving tool according to the invention:

According to the invention, a skiving tool is provided for machining tooth flanks of teeth of a workpiece. In order to machine the tooth flanks, the skiving tool is rotated about a tool axis and the workpiece is rotated about a workpiece axis that runs skew to the tool axis, wherein the skiving tool and the workpiece are displaced relative to one another by a feed motion with a component along the workpiece axis. Due to axis kinematics, the feed motion also has a component along the tool axis. Typically, the feed motion occurs in parallel with the workpiece axis.

The skiving tool has a plurality of cutting edges that successively remove material from the same tooth flank when machining the workpiece. A cutting edge is understood to mean an edge of the skiving tool which, during machining, removes material from the workpiece, in this case from a tooth flank of its teeth, by cutting. During machining, all the cutting edges can engage on each tooth flank or only some of the cutting edges can engage on a particular tooth flank.

According to the invention, it is provided that at least two of the cutting edges for machining the same tooth flank are arranged at different heights along the tool axis, wherein, for at least one radial distance from the tool axis, a distance measured along the tool axis between the corresponding points on the cutting edges arranged at different axial heights is at least 5 μm, in particular, at least 10 μm, and at most 0.5 mm, in particular, at most 0.3 mm. The axial distance between the displaced cutting edges can preferably be at least 20 μm, particularly preferably at least 30 μm, and/or preferably at most 0.2 mm, particularly preferably at most 0.15 mm. In particular, the line centers of the cutting edges arranged at different axial heights along the tool axis can be displaced with respect to one another by at least 5 μm, preferably at least 10 μm, particularly preferably at least 20 μm, very particularly preferably at least 30 μm and/or at most 0.5 mm, preferably at most 0.3 mm, particularly preferably at most 0.2 mm, very particularly preferably at most 0.15 mm.

The axially displaced cutting edges are used to machine tooth flanks of the same name (i.e., left or right). To machine the tooth flanks of the workpiece, the cutting edges of the skiving tool engage in the gaps between the teeth of the workpiece.

When machining a tooth flank, a plurality of cutting edges engage on this tooth flank one after the other and remove material therefrom each time. Since at least two of the cutting edges are offset with respect to one another in the axial direction of the tool axis, they do not engage on the respective tooth flank at equal time intervals but at varying time intervals; likewise, they do not engage on the respective tooth flank at equal distances but at varying distances, for example measured in the width direction of the tooth flank.

On the one hand, this means that during machining, engagement impacts are not repeated at a single frequency; rather, the engagement impacts occur with a broader frequency spectrum. This reduces vibrations that occur during machining and thus reduces feedback from the machining process between a skiving machine comprising the skiving tool and the workpiece comprising the teeth. On the whole, the machining process is smoother and more stable.

On the other hand, the variation in the distances between where the cutting edges engage causes the distances between feed marks or machining marks running across the tooth flank to differ from one another. In other words, the tooth flank has an (unavoidable) undulation that does not have a single wavelength, but a certain wavelength spectrum. When the teeth roll on mating teeth, excitations with a single frequency are therefore avoided; instead, there is broadband noise excitation. This results in better, and especially smoother, rolling behavior. In particular, the excitation of resonance frequencies can be avoided. Overall, teeth produced using the skiving tool according to the invention have optimized properties with regard to NVH (noise, vibration, harshness) aspects.

Cutting edges arranged at different axial heights in principle have different positions in the direction of the tool axis while being at the same distance from the tool axis, with the possible exception of individual points if the cutting edges are inclined toward one another. Preferably, two cutting edges arranged at different axial heights do not have the same axial position along the tool axis for any distance from the tool axis.

The cutting edges offset in the axial direction generally do not have the same geometry. This results from the fact that the body conjugated to the teeth to be produced is typically not a cylinder. The conjugated body is the (imaginary) body which, in the axis configuration of the skiving process for which the skiving tool is intended, would roll on the teeth (to be produced) at every point when said tool rotates about the tool axis and when the workpiece rotates about the workpiece axis. The profile of the offset cutting edges can therefore be adjusted accordingly in order to produce teeth that have the desired geometric properties.

The geometry of the cutting edges can be considered or defined as an intersection between the body conjugated to the teeth to be produced and a generating geometry of the corresponding cutting edge. In the simplest case, the generating geometry is a plane. Alternatively, the generating geometry can be, for example, a spherical surface. Other generating geometries are also conceivable. In order to define the offset cutting edges, a similar generating geometry can be moved in the direction of the tool axis and then be intersected by the conjugated body.

Preferably, the skiving tool is used in a machining method according to the invention as described below. The scope of the present invention also includes the use of a skiving tool according to the invention for machining tooth flanks of teeth, in particular, in a machining method according to the invention.

The skiving tool can have additional cutting edges which serve to machine other tooth flanks opposite to the (first) tooth flanks with respect to a tooth gap in each case. In particular, during the engagement of one of the (first) cutting edges on one of the first tooth flanks, the associated additional cutting edge can engage on the other tooth flank.

For at least two of the additional cutting edges, it is preferably the case that for at least one radial distance from the tool axis, a distance measured along the tool axis between the corresponding points on the additional cutting edges arranged at different axial heights is at least 5 μm, in particular, at least 10 μm, preferably at least 20 μm, particularly preferably at least 30 μm, and at most 0.5 mm, in particular, at most 0.3 mm, preferably at most 0.2 mm, particularly preferably at most 0.15 mm. Typically, during machining, a (first) cutting edge initially comes into engagement with a (first) tooth flank; while the first cutting edge removes material from the first tooth flank, the additional cutting edge can also come into engagement with the other tooth flank that is opposite the tooth gap. The additional cutting edges can be arranged relative to one another like the (first) cutting edges and designed accordingly.

The skiving tool can be provided for machining straight-toothed or helically toothed workpieces. The skiving tool can be cylindrical or conical.

In a preferred embodiment, the cutting edges arranged at different axial heights are offset in parallel with one another. In this case, the offset cutting edges extend at the same distance from one another (measured along the tool axis), regardless of the distance from the tool axis. This can simplify the design and production of the skiving tool.

In an alternative embodiment, the cutting edges arranged at different axial heights are inclined with respect to one another. In this case, the offset cutting edges have an increasing or decreasing distance from one another—measured along the tool axis—with increasing distance from the tool axis. At a certain distance from the tool axis, the distance may disappear; however, the cutting edges otherwise extend at different axial heights with respect to the tool axis. This results in variable distances between two feed marks made by the cutting edges. In other words, adjacent feed marks run toward or away from one another. The feed marks may cross. Teeth produced using this skiving tool display particularly smooth rolling behavior.

An advantageous embodiment of the skiving tool is characterized in that the cutting edges arranged at different axial heights each extend in one plane. The cutting edges usually have (one-dimensional) curvature in their corresponding plane. This can simplify the design and production of the skiving tool.

In an alternative embodiment, the cutting edges arranged at different axial heights have two-dimensional curvature. In particular, a hollow grind can be provided in this way. This can have an advantageous effect on chip formation.

A preferred development of this embodiment is characterized in that the cutting edges arranged at different axial heights have different curvatures when projected onto a plane containing the tool axis in each case, which plane is rotated by the angular increment between the cutting edges. This allows for establishing variable distances between the feed marks of two cutting edges. In other words, adjacent feed marks run toward or away from one another. The feed marks may cross. In addition, having a different curvature allows the cutting edges to be adapted to the conjugated body. Each projection plane can pass through a specific point, for example a radially innermost, outermost or central point, of each cutting edge.

It can be provided that the cutting edges arranged at different axial heights have different curvatures when projected onto a plane that is perpendicular to the tool axis. This allows controlling the shape of the teeth produced. In particular, it can be achieved that the cutting edges arranged at different heights each produce the same profile for the teeth. In other words, by the projection of the cutting edges having a different shape, they may be adapted to the conjugated body.

In a preferred embodiment, all the cutting edges of the skiving tool are arranged at different heights along the tool axis. In other words, each of the cutting edges has an individual axial position. This makes it possible to create a particularly wide pattern of feed marks that have different distances on the tooth flank.

An alternative embodiment is characterized in that the cutting edges of the skiving tool are divided into several groups, wherein corresponding cutting edges of different groups are each arranged at the same height along the tool axis. This can simplify the design and production of the skiving tool. This embodiment is particularly useful when each tooth flank is only machined by the cutting edges of one of the groups. A repeating pattern of a number of feed marks is created on each tooth flank, which pattern corresponds to the number of cutting edges in each group.

Preferably, all the cutting edges of each group are arranged at different heights along the tool axis. In other words, each of the cutting edges of one of the groups has an individual axial position. This makes it possible to create particularly wide patterns of feed marks that have different distances on the tooth flank.

An advantageous embodiment is characterized in that at least three of the cutting edges for machining the same tooth flank are arranged at different heights along the tool axis, wherein the second cutting edge is arranged at a different height with respect to the first cutting edge in a first direction along the tool axis and wherein the third cutting edge is arranged at a different height with respect to the second cutting edge in a second direction that is opposite the first direction, and is preferably also arranged at a different height with respect to the first cutting edge in the second direction. The first, second, third, etc. cutting edges are the cutting edges that are the first, second, third, etc. to successively come into engagement with each tooth flank during machining. In other words, the first, second, third, etc. cutting edges engage in each tooth gap in immediate succession and remove material from the adjacent tooth flank. This skiving tool creates feed marks whose distances alternately increase and decrease across the width of the tooth flank. This has proven to be particularly advantageous with regard to rolling behavior and noise generation.

It can be provided that cutting edges that are offset relative to one another in the axial direction are offset relative to one another in the radial direction with respect to the tool axis. In particular, radially outer tips of each of the cutting edges have different distances from the tool axis. Furthermore, the cutting edges can correspond in terms of their spatial shape. This may simplify adaption to the conjugated body.

Cutting edges that are offset with respect to one another in the axial direction can have a different pitch in the circumferential direction than cutting edges arranged at the same height. This is also how they can be adapted to the conjugated body. The different pitch allows the engagement of each cutting edge moved forward or backward in time due to the axial offset to be taken into account; the temporal offset corresponds to a different rotational position of the skiving tool with respect to a skiving tool with cutting edges that are not offset in the axial direction (angular offset during engagement). This angular offset can be mirror-inverted and transferred to the cutting edges. A different pitch with cutting edges offset in the axial direction is particularly useful in skiving tools for machining helical teeth.

### Machining Method According to the Invention:

The scope of the invention also includes a method for machining tooth flanks of teeth of a workpiece by skiving, in which a skiving tool is brought into engagement with the teeth, wherein the skiving tool is rotated about a tool axis and the workpiece is rotated about a workpiece axis running skew to the tool axis, and wherein the skiving tool and the workpiece are displaced relative to one another by a feed motion with a component along the workpiece axis. The skiving tool is preferably a skiving tool according to the invention as described above. Due to axis kinematics, the feed motion also has a component along the tool axis. Typically, the feed motion occurs in parallel with the workpiece axis. The speed of the feed motion is typically constant. An axis crossing angle of the tool axis and the workpiece axis can be at least 5°, preferably at least 10°, particularly preferably at least 15°, and/or at most 50°, preferably at most 40°, particularly preferably at most 30°.

The machining method according to the invention is characterized in that at least two of the cutting edges of the skiving tool, which machine the same tooth flank (in particular immediately) one after the other, are arranged at different heights along the tool axis, wherein for at least one radial distance from the tool axis, a distance measured along the tool axis between the corresponding points on the cutting edges arranged at different axial heights is at least 5%, in particular, at least 10%, and at most 95%, in particular, at most 90%, of the feed distance of the feed motion by which the skiving tool and the workpiece are moved with respect to one another along the workpiece axis between each of the cutting edges arranged at different axial heights machining the same tooth flank. The feed distance between two immediately successive cutting-edge engagements on the same tooth flank can be, for example, between 50 μm and 150 μm.

Due to the offset of the cutting edges successively engaging on the same tooth flank, the distances between the feed marks formed vary. If the subsequent cutting edge is offset in the feed direction, the distance between the feed marks is increased; if the subsequent cutting edge is offset counter to the feed direction, the distance between the feed marks is reduced. The offset cutting edges usually engage in a respective tooth gap with the tooth flank to be machined in immediate succession. In other words, the machining process is carried out in such a way that cutting edges that are axially offset with respect to one another remove material from each tooth flank immediately one after the other. On the skiving tool, the cutting edges offset with respect to one another are typically not arranged immediately adjacent to one another; rather, depending on the cutting sequence (depending on the number of teeth on the workpiece and the skiving tool), one or more cutting edges of the skiving tool can be located between cutting edges that engage on the same tooth flank in immediate succession.

On the one hand, the feed marks, which are arranged at different, preferably irregular, distances, improve the rolling behavior of the teeth. In particular, the noise or vibration behavior is improved by avoiding discrete frequency excitation and instead exciting a broader frequency spectrum with lower amplitude. On the other hand, a smoother and more stable machining process is achieved because the engagement impacts of the cutting edges occur at different time intervals. In particular, vibrations resulting from the fluctuating cutting forces that have negative effects on the machining process are reduced.

Between successive, offset cutting edges machining the same tooth flank, the workpiece is typically rotated by exactly one revolution. In doing so, the skiving tool can perform more (possible for internal or external teeth to be machined) or less (only possible for external teeth to be machined) than one revolution. Typically, the skiving tool does not perform complete revolutions between machining the same tooth flank, and therefore another cutting edge, in particular, one of the axially offset cutting edges, removes material from the respective tooth flank.

Machining with the skiving tool that has cutting edges arranged at different axial heights can be the last time material is removed from the tooth flanks of the teeth, in particular, the last time they are machined, in a production process. Machining by means of the skiving tool that has cutting edges arranged at different axial heights can, in particular, be the last time the tooth flanks of the teeth are processed. Alternatively, chemical, physical and/or thermal surface treatment, such as hardening, can be carried out following machining using the skiving tool having cutting edges arranged at different axial heights, wherein the geometric structure of the surface of the tooth flanks is typically not changed.

In a preferred method variant, machining using the skiving tool having cutting edges arranged at different axial heights is a hard-fine machining process that is carried out after the teeth have been hardened. The machining marks of this hard-fine machining process remain on the finished workpiece, and therefore the advantages of the method according to the invention become particularly apparent when the teeth produced are used.

Typically, soft machining of the teeth is carried out before they are hardened. Soft machining can be carried out, for example, by hobbing, planing, shaping or, preferably, skiving. Soft machining can also be carried out using the method according to the invention and/or a skiving tool according to the invention. In this respect, the invention also relates to a production method involving soft machining, hardening and hard-fine machining, wherein soft machining and/or hard-fine machining can be carried out using the method according to the invention.

In an alternative, advantageous method variant, machining using the skiving tool that has cutting edges arranged at different axial heights is a soft machining process, which is not followed by further removal of material from, in particular, further machining of, the tooth flanks. The surface structure on the tooth flanks created during soft machining is thus retained on the finished workpiece. With soft machining, the service life of the skiving tool can be increased compared to hard machining. Following soft machining using the skiving tool that has cutting edges arranged at different axial heights, chemical, physical and/or thermal surface treatment, in particular, hardening, can be carried out. For example, the tooth flanks or the entire workpiece can be nitrided. In this respect, the invention also relates to a production method involving soft machining, which is carried out using the method according to the invention, and subsequent non-abrasive surface treatment, in particular, hardening, of the tooth flanks, wherein the production method does not involve material-removing hard machining after the non-abrasive surface treatment. In this variant, generally a hardening process is used, which causes only slight distortion, such as nitriding, and therefore corrective post-machining can be dispensed with.

In a preferred method variant, successive machining marks are caused on the tooth flank by the cutting edges arranged at different axial heights, the distances between which tracks increase and decrease in a repeated pattern in a width direction of the teeth. For this purpose, each tooth flank is machined several times with the same cutting edges or with cutting edges offset in the same way. The pattern can comprise, for example, at least 5, preferably at least 10, particularly preferably at least 20, consecutive machining marks (feed marks). Within the pattern, the distances between the machining marks can continuously increase and decrease or, alternatively, increase and decrease several times, particularly in an irregular manner. A process that causes a repeated pattern can simplify the design and production of the skiving tool. In addition, it has been found that if the pattern is sufficiently wide, the advantages according to the invention can already be largely exploited both with regard to the use of the teeth and the implementation of the production method such that a larger number of machining marks in the pattern only brings about a comparatively small further improvement.

Further features and advantages of the invention can be found in the description, the claims, and the drawings. According to the invention, the aforementioned features and those which are to be explained below can each be used individually or as a plurality in expedient combinations of any kind. The embodiments shown and described are not to be understood as an exhaustive list, but, rather, have an exemplary character for the description of the invention.

### BRIEF DESCRIPTION OF THE DRAWINGS

The invention is shown in the drawings and is described on the basis of embodiments. In the drawings:

FIG. 1 is a schematic view of skiving teeth with the relevant axes of movement;

FIG. 2 is a schematic view of the teeth in FIG. 1 and a body conjugated to the teeth;

FIG. 3 is a schematic perspective view of a skiving tool according to the prior art;

FIG. 4 is an enlarged schematic perspective view of a cutting tooth of a skiving tool;

FIG. 5 is a schematic view of the positions of cutting edges along the tool axis in a skiving tool according to the prior art;

FIG. 6 is a schematic view of the sequence in which cutting edges engage on a tooth flank during the skiving process according to the prior art;

FIG. 7 is a schematic view of machining marks on a tooth flank during the skiving process according to the prior art;

FIG. 8 is a schematic perspective view of a skiving tool according to the invention with cutting edges stochastically offset along the tool axis;

FIG. 9 is a schematic view of the positions of cutting edges successively engaging on a tooth flank relative to a nominal position along the tool axis in a skiving tool from FIG. 8;

FIG. 10 is a schematic view of the sequence in which cutting edges engage on a tooth flank during the skiving process according to the invention, for example using the skiving tool from FIG. 8;

FIG. 11 is a schematic view of machining marks on a tooth flank during the skiving process according to the invention, for example using the skiving tool from FIG. 8;

FIG. 12 shows a contour of a cutting tooth of a skiving tool according to the invention, wherein cutting edges extend in a plane that is perpendicular to the tool axis;

FIG. 13a shows a contour of a cutting tooth of a skiving tool according to the invention, wherein cutting edges extend in a plane that is inclined with respect to the tool axis;

FIG. 13b shows a contour of a cutting tooth of a skiving tool according to the invention, wherein cutting edges extend with two-dimensional curvature from a plane that is perpendicular to the tool axis;

FIG. 14 is a schematic perspective view of a skiving tool according to the invention, comprising several groups of cutting edges offset along the tool axis;

FIG. 15 is a schematic view of the positions of cutting edges which successively engage on a tooth flank and are stochastically offset in groups, shown relative to a nominal position along the tool axis, in a skiving tool according to the invention;

FIG. 16 is a schematic view of the positions of cutting edges which successively engage on a tooth flank and are regularly offset in groups, shown relative to a nominal position along the tool axis, in a skiving tool according to the invention;

FIG. 17 is a schematic view of machining marks on a tooth flank during the skiving process according to the invention, wherein distances between two adjacent machining marks change over the tooth height; and

FIG. 18 is a schematic view of intersecting machining marks on a tooth flank during the skiving process according to the invention.

### Detailed Description of the Preferred Embodiments

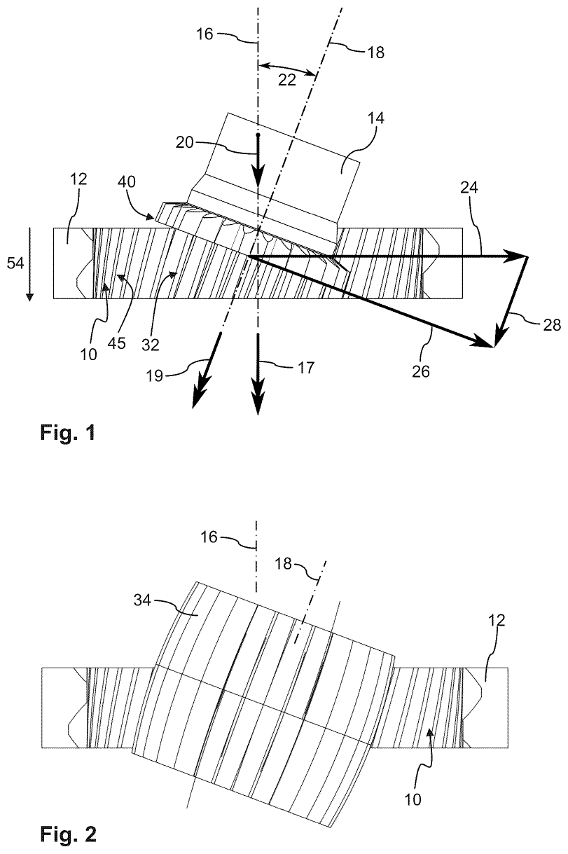

FIG. 1 shows a representation of the kinematics of skiving the teeth 10 of a workpiece 12 using a skiving tool 14. In this example, the workpiece 12 here has internal teeth. Skiving a workpiece with external teeth is carried out in principle with the same movements. The kinematics shown in FIG. 1 applies equally to a skiving process known from the prior art as well as to skiving processes according to the invention that use skiving tools according to the invention.

For skiving, the toothed skiving tool 14 is brought into engagement with the teeth 10 to be machined. The workpiece 12 comprising the teeth 10 is rotated about a workpiece axis 16, as indicated by a double-headed arrow 17. At the same time, the skiving tool 14 is rotated about a tool axis 18, as indicated by a double-headed arrow 19. The rotational speeds are coordinated with one another. During the coupled rotational movement, a feed motion 20, which typically runs along the workpiece axis 16, is performed.

The workpiece axis 16 and the tool axis 18 extend skew to one another. When projected onto a plane that is perpendicular to the common orthogonal of the axes 16, 18, an axis crossing angle 22 is created, which can, for example, be between 10° and 45°. Typically, the axes 16, 18 extend in parallel with the plane that is perpendicular to the common orthogonal; however, the axes 16, 18 can optionally also be inclined toward or away from one another so that an angle of inclination is established (not shown in detail).

The peripheral speeds in the contact zone resulting from the rotational movements of the workpiece 12 and the skiving tool 14 are indicated by an arrow 24 for the workpiece 12 and an arrow 26 for the skiving tool 14. The vectorial difference of these peripheral speeds 24, 26 results in a cutting speed 28. The feed rate of the feed motion 20 is generally of no significance for the cutting speed. The feed motion 20 causes that as the cutting edges 40 successively engage, the machining process advances in the width direction 54 of the teeth, along the tooth flanks 32.

During skiving, the teeth 10 can be machined from a workpiece without teeth. It is also possible to rework by skiving a workpiece 12, previously provided with teeth. Skiving can be carried out, in particular, after the workpiece 12 previously provided with teeth has been hardened.

To determine the shape of the cutting edges 40 of the skiving tool 14, reference can be made to the so-called conjugated body 34 of the teeth 10 to be produced; cf. FIG. 2. The conjugated body 34 is an imaginary body which is defined by the fact that in the axis configuration of the skiving process to be carried out, when said tool rotates about the tool axis 18 and when the workpiece 12 rotates about the workpiece axis 16, it would roll at every point on the teeth 10 (to be produced). The cutting edges 40 can be defined as lines where the conjugated body 34 intersects a generating geometry, for example a plane or a sphere.

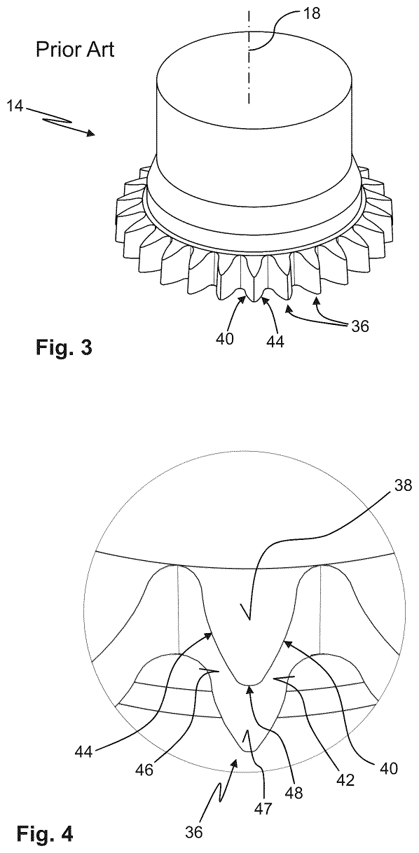

In skiving tools 14 from the prior art, all the cutting edges are arranged at the same height along the tool axis 18. In the simplest case, the generating geometry can be the same plane perpendicular to the tool axis 18 for all the teeth of the skiving tool 14. Such a skiving tool 14 known from the prior art is shown in FIG. 3.

FIG. 4 is an enlarged view of a cutting tooth 36 of a skiving tool. The following explanations of the structure of the cutting tooth 36 apply equally to skiving tools according to the invention as well as to those known from the prior art.

A rake face 38 is formed on the end face of the cutting tooth. A (first) cutting edge 40 separates the rake face 38 from a (first) tool flank 42. During skiving, the cutting edge 40 removes material from the first tooth flanks 32 of the teeth 10. An additional cutting edge 44 is used to machine the other tooth flanks 45 that are opposite with respect to a gap between each of the teeth 10 (cf. FIG. 1). The additional cutting edge 44 separates the rake face 38 from an additional tool flank 46. At the top of the cutting tooth 36, adjacent to a top tool flank 47, a top cutting edge 48 is formed for machining the root region of the teeth 10. A rake face bevel can be arranged between the cutting edges 40, 44, 48 and the rake face 38 (not shown in detail). A flank bevel can be arranged between the cutting edges 40, 44, 48 and the respective tool flanks 42, 46, 47 (not shown in detail).

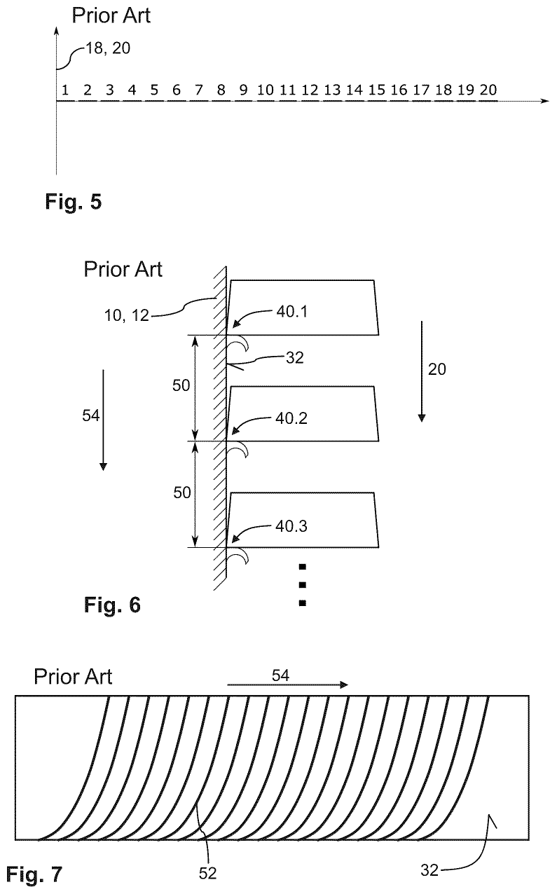

In skiving tools 14 known from the prior art, the cutting edges 40 are arranged at the same heights along the tool axis 18, as already explained; this is shown in FIG. 5 for the cutting edges 40 which successively engage on a tooth flank 32, wherein the tooth flank 32 is machined by 20 cutting edges 40 one after the other, in this example. In the skiving tool 14 that has cutting edges 40 arranged at the same height, these cutting edges 40 (here, for example, a first cutting edge 40.1, a second cutting edge 40.2 and a third cutting edge 40.3) engage with the tooth flank 32 to be machined at equal distances 50; cf. FIG. 6. Accordingly, machining marks (feed marks) 52 run at equal distances over the tooth flank 32; cf. FIG. 7. Adjacent machining marks 52 are shifted in parallel in width direction 54. Corresponding machining marks are formed for the remaining tooth flanks of the teeth 10. This results in an excitation with a single (discrete) frequency during operation of the teeth 10 produced, depending on the rotational speed.

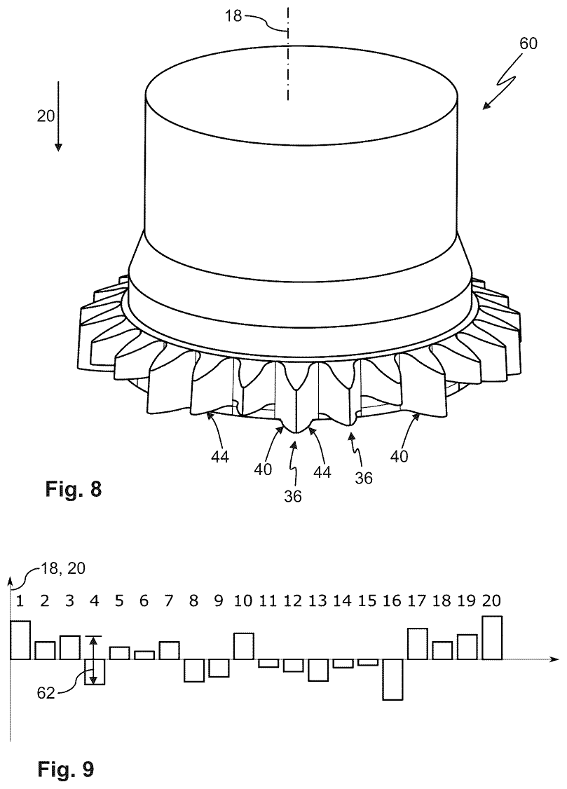

FIG. 8 shows a skiving tool 60 according to the invention in a first embodiment. In the skiving tool 60, the cutting edges 40 (and the additional cutting edges 44) are offset with respect to one another along the tool axis 18. In FIG. 9, the axial offset of, in this example, 20 cutting edges 40 is shown, which successively remove material from one of the tooth flanks 32 to be machined. On the skiving tool 60, the cutting edges 40, which engage immediately one after the other on the same tooth flank 32, are typically not directly adjacent to one another (due to the ratio of the number of teeth of the skiving tool 60 and the workpiece 12 in each case).

Some of the cutting edges 40 are offset forward in the direction of the feed motion 20 along the tool axis 18 (ordinate in FIG. 9) with respect to a nominal position (at the height of the abscissa) in the direction of the feed motion 20, and some of the cutting edges 40 are offset backward counter to the direction of the feed motion 20. The height offset 62 between the cutting edges 40 which successively engage on the tooth flank 32 in question can, for example, be between 10 μm and 80 μm. In FIG. 9, the height offset 62 between the fourth and fifth cutting edges 40 is shown by way of example, which cutting edges engage on the tooth flank 32 in question, and can be 60 μm in the exemplary embodiment shown. For the other pairs of successively engaging cutting edges 40, other values result for the height offset 62 within the above-mentioned range.

It can also be seen from FIG. 9 that for some of the cutting edges 40 engaging on the tooth flank 32 one after the other, the direction of the offset changes with respect to the previously engaging cutting edge 40. For example, the third cutting edge is further offset in the direction of the feed motion 20 with respect to a nominal position than the second cutting edge. In contrast, the fourth cutting edge is offset with respect to the third and also the second cutting edge in the opposite direction to the feed motion 20. The same also applies to the sixth, seventh and eighth engaging cutting edges and, with the opposite sign, to the twelfth, thirteenth and fourteenth cutting edges or the fifteenth, sixteenth and seventeenth cutting edges. In this way, particularly irregular distances between the machining marks can be obtained.

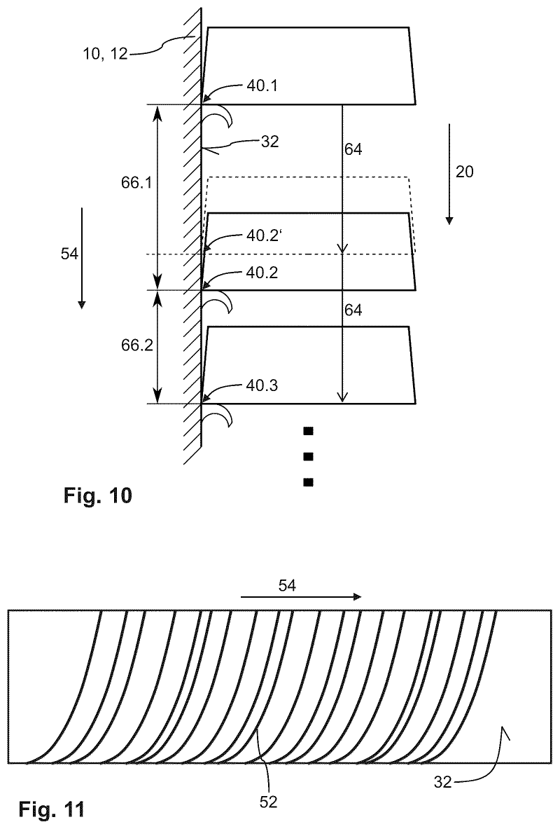

FIG. 10 schematically shows how the cutting edges 40 (here, for example, a first cutting edge 40.1, a second cutting edge 40.2 and a third cutting edge 40.3) engage one after the other on the tooth flank 32 in question during the skiving process according to the invention, for example using the skiving tool 60. In FIG. 10, the axial position of the first cutting edge 40.1 along the tool axis 18 is chosen as the reference point. For orientation purposes, the engagement situation is shown in dashed lines that would result with a skiving tool 14 having cutting edges arranged at the same height (the imaginary second cutting edge arranged at the height of the first cutting edge 40.1 is denoted by 40.2′). A distance between the cutting edge 40.1 and the imaginary cutting edge 40.2′ thus corresponds to the feed distance 64 between two successive points where the cutting edges engage in the same tooth flank 32.

In the example shown, the second cutting edge 40.2 is offset forward in the direction of the feed motion 20 along the tool axis 18. A first distance 66.1 measured in the width direction 54 of the tooth flank 32 between points where the first cutting edge 40.1 and the second cutting edge 40.2 engage is thus greater than the feed distance 64. If the third cutting edge 40.3—as shown in FIG. 10—is arranged at the height of the first cutting edge 40.1 along the tool axis 18, a second distance 66.2 between points where the second cutting edge 40.2 and the third cutting edge 40.3 engage is smaller than the feed distance 64 and the first distance 66.1.

The feed distance 64 between two cutting edge engagements on the tooth flank 32 in question can be, for example, 100 μm. In this exemplary embodiment, the height offset 62 is therefore between 10% and 80% of the feed distance 64.

In the skiving tool 60, the cutting edges 40 are stochastically offset along the tool axis 18. In particular, all the cutting edges 40 can be arranged at different heights along the tool axis 18. A corresponding result of machining marks on the tooth flank 32 is shown in FIG. 11.

If the cutting edges 40 are offset in parallel with one another, adjacent machining marks 52 are shifted in parallel in the width direction 54. However, distances between adjacent machining marks 52 differ according to the height offset between the cutting edges 40 creating them.

Corresponding machining marks are formed for the remaining tooth flanks of the teeth 10. This results in an excitation with a frequency spectrum of a certain width during operation of the teeth 10 produced, depending on the rotational speed.

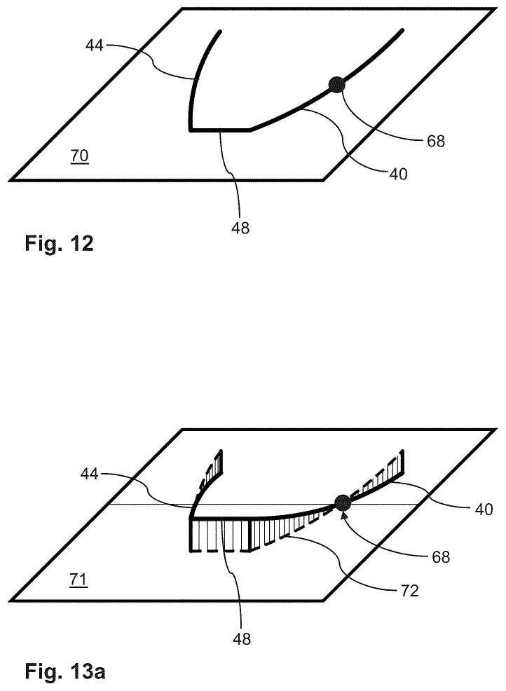

The height offset 62 between the cutting edges 40 can be measured at a selected radial distance from the tool axis 18. In particular, it is possible to use a line center 68 of each of the cutting edges 40 as a basis, which center divides the cutting edge 40 into two cutting-edge portions of equal length; cf. FIG. 12.

FIG. 12 also shows that each cutting edge 40 (and also the associated additional cutting edge 44 and, if applicable, the top cutting edge 48) can extend in a plane 70. The cutting edge 40 is, in principle, curved in this plane 70. The plane 70 corresponds to the generating geometry, with the cutting edge 40 being defined by said generating geometry being intersected by the conjugated body 34 (cf. FIG. 2).

The plane 70 can be oriented perpendicularly to the tool axis 18. In particular, the cutting edges 40 can be offset in parallel with one other in parallel planes 70.

However, it is also conceivable that the plane 70 in which one of the cutting edges 40 extends is inclined relative to the tool axis 18. In particular, cutting edges 40 at different heights can have different inclinations for their corresponding plane 70.

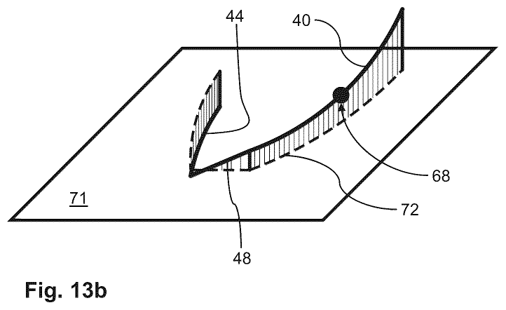

Therefore, FIG. 13a shows, by way of example, a cutting edge 40 (and also the associated additional cutting edge 44 and, optionally, the top cutting edge 48), which extends in a plane that is inclined with respect to a plane 71 perpendicular to the tool axis 18. In this case, the generating geometry is a plane that is inclined with respect to the tool axis 18.

FIG. 13b shows that each cutting edge 40 (and also the associated additional cutting edge 44 and optionally the top cutting edge 48) can be two-dimensionally curved in space; they therefore do not extend in one plane. The generating geometry in this case is a surface curved in space.

It is possible to use a certain radial distance from the tool axis 18 as a basis for determining the height offset 62 for the shapes of the cutting edges 40 shown in FIG. 13a, 13b. Likewise, the height offset 62 can be determined for each of the line centers 68.

Profiles of projections 72 of the cutting edges 40 on the plane 71 that is perpendicular to the tool axis 18 can differ for the offset cutting edges 40.

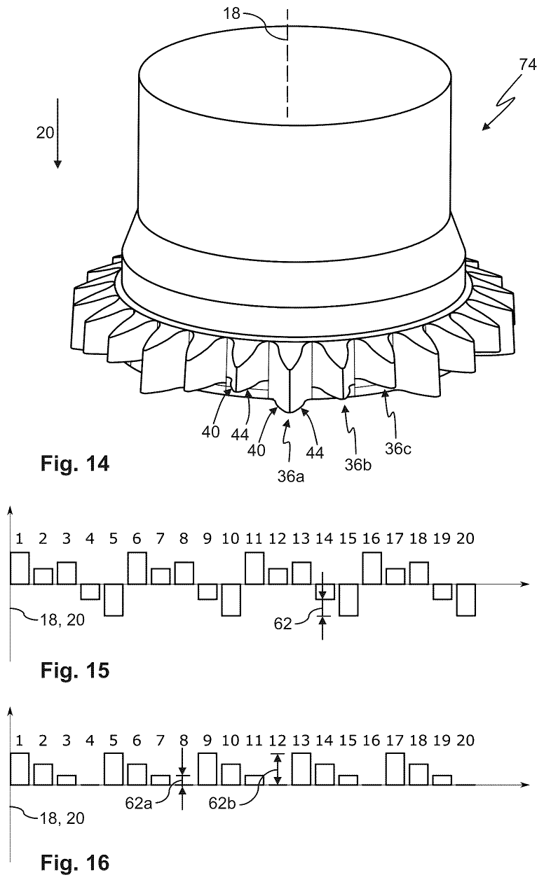

FIG. 14 shows a skiving tool 74 according to the invention, in which the cutting edges 40 are divided into groups. Here, each group comprises, for example, three cutting teeth 36a, 36b, 36c arranged at different heights along the tool axis 18, each with a cutting edge 40 and additional cutting edge 44. In the exemplary embodiment shown, all the cutting edges 40, 44 of each group extend at different heights with respect to the tool axis 18. Corresponding cutting edges 40, 44 of the cutting teeth 36a, 36b, 36c of different groups are each located at the same axial height.

FIG. 15 shows the axial offset of, for example, 20 cutting edges 40 in this case, which successively remove material from one of the tooth flanks 32 to be machined. The cutting edges 40 are divided into groups of five cutting edges 40 each. Within a group, the axial position of the cutting edges 40 and the height offset 62 between successively engaging cutting edges 40 vary randomly, but in the same way in all the groups.

FIG. 16 shows the axial offset of, once again by way of example, 20 cutting edges 40 which are divided into groups of four cutting edges 40 each. Within each group, when machining one of the tooth flanks 32, successive cutting edges 40 are evenly offset in one direction relative to the preceding cutting edge 40. Here, the offset of the cutting edges 40 decreases in the direction of the feed motion 20 in uniform steps. A height offset 62a between cutting edges 40 engaging successively on one of the tooth flanks 32 is the same size within each group. When changing from the last cutting edge 40 of one of the groups to the first cutting edge 40 of the next group, a larger height offset 62b correspondingly results in the direction of the feed motion 20.

With skiving tools whose cutting edges are offset in accordance with FIG. 15 or 16, repeated patterns of machining marks are produced on a tooth flank during the machining process (not shown in detail). Within the pattern sequences, the distances between adjacent machining marks increase and decrease in the same way each time.

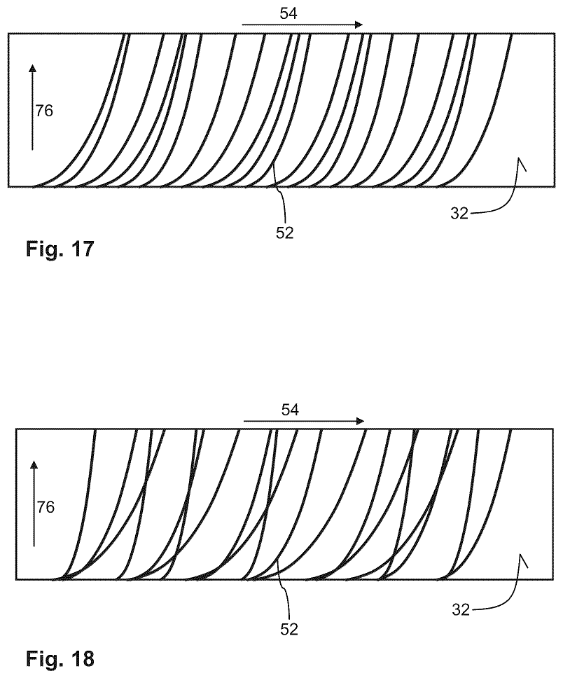

FIG. 17 shows machining marks 52 which can be produced during the process according to the invention of machining a tooth flank 32 by means of cutting edges 40 that are inclined with respect to one another. Due to the different inclinations, the axial position of successively engaging cutting edges differs for practically all radial distances from the tool axis 18; only for a single radial distance successively engaging cutting edges can have the same axial position.

During skiving, the contact zone between the workpiece 10 and skiving tool moves along the engaged cutting edge. If the cutting edge is inclined relative to a plane 70 that is perpendicular to the tool axis 18, the machining marks 52 are therefore steeper or flatter in the vertical direction 76 of the machined tooth flank 32, depending on the inclination of the cutting edge. Adjacent machining marks therefore approach or move away from one another as they progress. This means that during operation of the teeth produced, the excitation by the unavoidable undulations of the tooth flank 32 does not excite a discrete frequency, but a broader frequency spectrum.

FIG. 18 shows machining marks 52 which can be produced during the process according to the invention of machining a tooth flank 32 by means of cutting edges 40 that are inclined with respect to one another and additionally displaced in the axial direction. The machining marks 52 partially cross.

In summary, the invention relates to machining teeth by skiving, wherein machining marks having unequal distances and possibly different running directions are produced. For this purpose, at least some cutting edges of a skiving tool at least partially extend at different heights along a tool axis of the skiving tool. During machining, cutting edges arranged at different axial heights relative to the workpiece axis successively engage on a tooth flank. The cutting edges thus engage at different time intervals and at different distances in the width direction of the tooth flank. The effects of the engagement of the cutting edges on the machining process and the excitation of vibrations when the teeth produced are used therefore have a frequency spectrum of greater width and lower amplitude than would be the case if the cutting edges were to engage at equal time intervals and equal distances. In particular, the more irregular surface structure of the teeth produced can have a positive effect on the noise excitation behavior when the teeth engage with mating teeth.

### LIST OF REFERENCE SIGNS

teeth 10
workpiece 12
skiving tool 14
workpiece axis 16
double-headed arrow 17
tool axis 18
double-headed arrow 19
feed motion 20
axis crossing angle 22
peripheral speed 24 (for the workpiece 12)
peripheral speed 26 (for the skiving tool 14)
cutting speed 28
tooth flank 32
conjugated body 34
cutting tooth 36; 36a, 36b, 36c
rake face 38
cutting edge 40; 40.1, 40.2, 40.3
virtual cutting edge 40.2′
tool flank 42
additional cutting edge 44
other tooth flank 45
additional tool flank 46
top tool flank 47
top cutting edge 48
distance 50
machining marks 52
width direction 54
skiving tool 60
vertical offset 62; 62a, 62b
feed distance 64
distance 66.1, 66.2
line center 68
plane 70 of the cutting edge
plane 71 orthogonal to the tool axis
projection 72
skiving tool 74

What is claimed is:

1. A skiving tool configured for machining tooth flanks of teeth of a workpiece, comprising:
wherein, when the skiving tool is rotated about a tool axis and the workpiece is rotated about a workpiece axis running skew to the tool axis, the skiving tool and the workpiece are displaced relative to one another with a feed motion with a component along the workpiece axis;
wherein the skiving tool has a plurality of cutting edges which successively remove material from the same tooth flank when machining the workpiece;
wherein at least two of the cutting edges for machining the same tooth flank are arranged at different heights along the tool axis, it being the case for at least one radial distance from the tool axis that a distance measured along the tool axis between the corresponding points on the cutting edges arranged at different axial heights is at least 5 μm and at most 0.5 mm.

2. The skiving tool according to claim 1, wherein the cutting edges arranged at different axial heights are offset in parallel with one another.

3. The skiving tool according to claim 1, wherein the cutting edges arranged at different axial heights are inclined with respect to one another.

4. The skiving tool according to claim 1, wherein the cutting edges arranged at different axial heights each extend in a plane.

5. The skiving tool according to claim 1, wherein the cutting edges arranged at different axial heights have two-dimensional curvature.

6. The skiving tool according to claim 5, wherein the cutting edges arranged at different axial heights have different curvatures when projected onto a corresponding plane containing the tool axis, which plane is rotated by the angular increment between the cutting edges.

7. The skiving tool according to claim 1, wherein the cutting edges arranged at different axial heights have different curvatures when projected onto a plane that is perpendicular to the tool axis.

8. The skiving tool according to claim 1, wherein all the cutting edges of the skiving tool are arranged at different heights along the tool axis.

9. The skiving tool according to claim 1, wherein the cutting edges of the skiving tool are divided into several groups, corresponding cutting edges of different groups each being arranged at the same height along the tool axis.

10. The skiving tool according to claim 9, wherein all the cutting edges of each group are arranged at different heights along the tool axis.

11. The skiving tool according to claim 1, wherein the line center of each of the cutting edges arranged at different axial heights is shifted with respect to one another along the tool axis by at least 5 μm and/or at most 0.5 mm.

12. The skiving tool according to claim 1, wherein at least three of the cutting edges for machining the same tooth flank are arranged at different heights along the tool axis, the second cutting edge being arranged at a different height with respect to the first cutting edge in a first direction along the tool axis and the third cutting edge being arranged at a different height with respect to the second cutting edge in a second direction that is opposite the first direction.

13. The skiving tool according to claim 1, wherein cutting edges that are offset relative to one another in the axial direction are offset relative to one another in the radial direction with respect to the tool axis.

14. The skiving tool according to claim 1, wherein cutting edges that are offset relative to one another in the axial direction have a different pitch in the circumferential direction than cutting edges arranged at the same height.

15. The skiving tool according to claim 1, wherein the at least one radial distance from the tool axis that a distance measured along the tool axis between the corresponding points on the cutting edges arranged at different axial heights is at least 10 μm and at most 0.3 mm.

16. The skiving tool according to claim 1, wherein the line center of each of the cutting edges arranged at different axial heights is shifted with respect to one another along the tool axis by at least 10 μm and/or at most 0.3 mm.

17. The skiving tool according to claim 12, wherein the third cutting edge is also arranged at a different height with respect to the first cutting edge in the second direction.

18. A method for machining tooth flanks of teeth of a workpiece by skiving, comprising the steps of:
providing a skiving tool having a plurality of cutting edges;
bringing the skiving tool into engagement with the teeth;
rotating the skiving tool about a tool axis and the workpiece being rotated about a workpiece axis running skew to the tool axis; and
displacing the skiving tool and the workpiece relative to one another with a feed motion with a component along the workpiece axis,
wherein at least two of the cutting edges of the skiving tool, which successively machine the same tooth flank, are arranged at different heights along the tool axis, it being the case that for at least one radial distance from the tool axis, a distance measured along the tool axis between the corresponding points on the cutting edges arranged at different axial heights is at least 5% and at most 95% of the feed distance of the feed motion by which the skiving tool and the workpiece are moved with respect to one another along the workpiece axis between each of the cutting edges arranged at different axial heights machining the same tooth flank.

19. The method according to claim 18, wherein the machining process with the skiving tool having cutting edges arranged at different axial heights is a hard-fine machining process which is carried out after the teeth have been hardened.

20. The method according to claim 18, wherein the machining process with the skiving tool having cutting edges arranged at different axial heights is a soft machining process, which is not followed by any further material-removing machining of the tooth flanks.

21. The method according to claim 18, wherein successive machining marks are caused on the tooth flank by the cutting edges arranged at different axial heights, the distances between which marks increase and decrease in a width direction of the teeth in a repeated pattern.

22. The method according to claim 18, wherein the distance measured along the tool axis between the corresponding points on the cutting edges arranged at different axial heights is at least 10% and at most 90% of the feed distance of the feed motion by which the skiving tool and the workpiece are moved with respect to one another along the workpiece axis between each of the cutting edges arranged at different axial heights machining the same tooth flank.
